(19) United States
(12) Patent Application Publication
(10) Pub. No.: US 2019/0387784 A1
(43) Pub. Date: Dec. 26, 2019

(54) Electromagnetically tightening & losing, electromagnetically cutting and second eatable-stuff input puffing machine

(71) Applicants: ZONGEN LI, Scarborough (CA); LI LI, Chongqing (CN); YICHENG SUN, Chongqing (CN)

(72) Inventors: ZONGEN LI, Scarborough (CA); LI LI, Chongqing (CN); YICHENG SUN, Chongqing (CN)

(21) Appl. No.: 15/952,241

(22) Filed: Apr. 13, 2018

(51) Int. Cl. A23P 30/34

(52) U.S. Cl. CPC A23P 30/34

(57) ABSTRACT

A puffing machine is equipped with all of the assemblies: 2 is an electromagnetically cutting assembly—when the cut push-pull electromagnet is powered on, the core of the push-pull electromagnet will drive bar linkage and blade(s) to move open or close in the right or left direction so that the blade(s) can cut off the puffed food; 3 is an electromagnetically tightening & losing assembly—when the push-pull electromagnet is powered on, the friction wheel will be pressed on the surface of the big wheel so that the tightening or the losing consequences are reached by the movements of the end plate; 4 is a second eatable stuff input assembly—this assembly can bring the second eatable stuff into the central area of the puffed tubular food extruded by the main structure assembly of puffing machine 1.

### CROSS-REFERENCE TO RELATED APPLICATIONS

### U.S. Patent Documents

| | | | |
|---|---|---|---|
| 3,530,491 | September 1970 | J. J. REJSA | 107/69 |
| 3,291,032 | December 1966 | G. O. GRAVES | 99/238 |
| 5,138,937 | August 1992 | Douglas A. Zietlow | 99/323.4 |

### Foreign Patent Documents

| CN | 103005652A | (Application No. 201210586402.5) | April 2013 |
|---|---|---|---|
| CN | 2217890Y | (Application No. 95210495.4) | January 1996 |
| CN | 2919894Y | (Application No. 200620021141.2) | June 2006 |
| CN | 203814576 | (Application No. 201420254177.X) | May 2014 |
| CN | 203087494 | (Application No. 201320087701.4) | July 2013 |

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUP AND BRIEF SUMMARY OF THE INVENTION

The invention is related to a puffing machine with an electromagnetically tightening & losing assembly and an electromagnetically cutting assembly and a second eatable stuff input assembly.

By searching various forms of media, such as the google patent, the US patent database, some newspapers and magazine databases, . . . etc. in the world, we know there are some typical instances of the puffing machines with their own tightening & losing assemblies to obtain a high pressure chamber, cutting assemblies to cut off the puffed food and the second eatable stuff input assemblies to get double color puffed food in the patent publications.

In the publication of the google patent database with the pub. number CN2919894Y, named as “small size single-phase corn puffing machine”, it uses the thread connection between a machine head (13) and an outer sleeve (10) of the machine to form the high pressure chamber (Note: The component numbers in this paragraph come from the publication CN2919894Y). In order to connect these two components together in the right way, the users of the machine must hold some skills and physical power. These requirements are not convenient for the normal people to operate “the small size single-phase corn puffing machine”. To improve these inconvenient operating conditions, we have invented a new assembly to achieve the connection of the puffing machine just by pushing a button. The independent claim for the invented assembly is listed in claim 1 of this application. The similar situations exist in the U.S. Pat. No. 3,291,032. In addition, the invented assembly has already been applied for the patent in P. R. China. The publication number is CN 107028213A (Application Number is 201710323019.3). The application date is May 9, 2017.

In the publication of google patent database with the pub. number CN 103005652A, named as “bulking machine”, it is equipped with the cutting assembly for the puffed food. The cutting assembly comprises of the rear end of the gear 14, shear drive shaft 13, the front end of the gear 11, the cutter shaft 10, cutter plate 9 and cutter 8 (Note: The component numbers in this paragraph come from the publication CN103005652A). The users of the bulking machine are hard to change cutting length of the puffed food. When the length of the puffed food has to be changed, the machine must be stopped and the ratio of gears should be altered. To change the cutting length of the puffed food at any time, we have invented a new assembly to complete the job just by pressing a button. The independent claim of this invented assembly can be checked in claim 8 of this application. The similar situations happen in U.S. Pat. No. 4,240,779. Besides, the invented assembly has already been applied for the patent in P. R. China. The publication number is CN107048456A (Application Number is 201710322637.6). The application date is May 9, 2017.

In the publication of google patent database with pub. number CN203814576U (Application Number is 201420154177.X), named as “machine capable of producing double-color puffed food or puffing two materials simultaneously”, the machine cannot be used for making tubular puffed food with second eatable stuff in the central area. In order to acquire the new type puffed food—outside lay is puffed food and the central area is filled by another eatable stuff, such as onion, lettuce . . . , we have invented a new assembly to accomplish the goal. The independent claim of this invented assembly can be seen in claim 16 of this application.

### BRIEF DESCRIPTION OF THE DIFFERENT VIEWS OF THE DRAWINGS

FIG. 1 is an isometric drawing of entire puffing machine, including three invented assemblies. They are the electromagnetically cutting assembly 2, the electromagnetically tightening & losing assembly 3, the second eatable stuff input assembly 4. And FIG. 1 also demonstrates the position relationship between the three invented assemblies and main structure of puffing machine 1.

FIG. 2 is an isometric drawing of the invented electromagnetically cutting assembly 2, the parallel-cutting type—one of the preferred embodiments.

FIG. 3A is an isometric view of the invented electromagnetically cutting assembly 2, the flying-knife type—another of the preferred embodiments.

FIG. 3B is an enlarged partial isometric view I of the flying-knife connection place in the invented electromagnetically cutting assembly 2

FIG. 4 is a front view of the electromagnetically cutting assembly 2 for the parallel-cutting type.

FIG. 5 is a partial view II of the electromagnetically cutting assembly 2 to show the details of limit switch position.

FIG. 6 is a partial view III of the electromagnetically cutting assembly 2 to depict the principle of the spring-back mechanism for the parallel-cutting type.

FIG. 7 is an isometric view of the invented electromagnetically tightening & losing assembly 3 to illustrate the transmission principles of the assembly.

FIG. 8 is an isometric view of the beginning separate portion from the invented electromagnetically tightening & losing assembly 3.

FIG. 9 is a top view of the invented electromagnetically tightening & losing assembly 3 and the invented second eatable stuff input assembly 4 to depict the assembly positions in the main frame.

FIG. 10 is a partial view IV of the invented electromagnetically tightening & losing assembly 3 to illustrate where the tightening & losing movements start from.

FIG. 11 is an isometric view of the invented second eatable stuff input assembly 4 to show the position of the assembly in the main frame.

FIG. 12 is a section view V-V of the invented second eatable stuff input assembly 4 and demonstrates the relationship between the main structure of puffing machine 1, the invented electromagnetically tightening & losing assembly 3 and the invented second eatable stuff input assembly 4.

FIG. 13 is an isometric view of the invented second eatable stuff input assembly 4.

Among these drawings, the sequence numbers and the corresponding part names are listed as following:

1 Main structure of puffing machine, 2 Electromagnetically cutting assembly, 3 Electromagnetically tightening & losing assembly, 4 Second eatable stuff input assembly, 101 Motor, 102 Main base, 103 Sleeve support base, 104 Motor switch, 105 Pulley friction wheel, 106 Thread shaft, 107 Chamber sleeve, 108 Sleeve support, 109 Electric control box, 110 Main belt, 111 Hopper for puffing food stuff 201 Cutting assembly base, 202 Cut push-pull electromagnet, 203 Shock absorber, 204 V-chute shaft, 205 Trigger for limit switch, 206 Core of push-pull electromagnet, 207 V-chute plate, 208 Check valve, 209 Upper pin shaft, 210 Upper arm, 211 Arm pin shaft, 212 Lower arm, 213 Back-position nut, 214 Back-position spring, 215 Back-position pin shaft, 216 Support pin, 217 Guide pin, 218 Blade, 219 Blade seat, 220 Limit switch, 221 Right cut relay button, 222 Left cut relay button, 223 Long blade, 224 tightening screw, 225 air opening, 301 Push-pull electromagnet, 302 Tightening relay switch, 303 losing relay switch, 304 Base for push-pull electromagnet, 305 Position plate, 306 Impact block, 307 Losing friction wheel, 308. Rocking arm, 309 Losing gear, 310 Dual gear, 311 Pin shaft for dual gear, 312 Dual gear support, 313 Driven plate, 314 Drive screw, 315 Drive support, 316 Gear nut, 317 Big dual gear, 318 Pull-back spring, 319 Losing shaft, 320 Tightening gear, 321 Tightening shaft, 322 Tightening friction wheel, 323 Bar of push-pull electromagnet, 324 Speed sensor, 325 Limit switch, 401 Hopper for second eatable stuff, 402 Big pulley, 403 Long screw, 404 Cotton pin, 405 Linkage, 406 Belt, 407 Tensioner shaft, 408 Small pulley, 409 Base for tensioner, 410 Belt adjustment, 411 Tensioner, 412 Big pulley plate, 413 Big pulley shaft, 414 Shaft base, 415 Tightening nut, 416 Connection sleeve, 417 Long tube.

### DETAILED DESCRIPTION OF THE INVENTION AND THE PREFERRED

### Embodiments

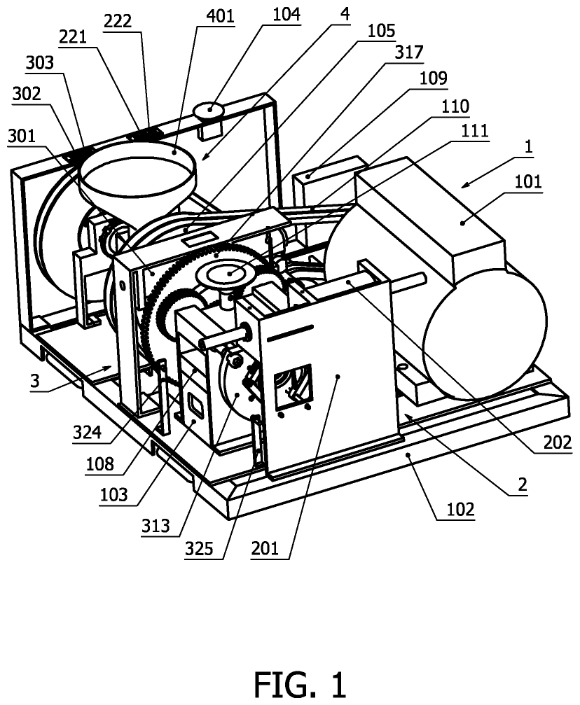

With reference to FIG. 1, it will be seen that the puffing machine comprises several assemblies, including the main structure of puffing machine 1, the electromagnetically cutting assembly 2, the electromagnetically tightening & losing assembly 3 and the second eatable stuff input assembly 4. FIG. 1 also depicts the respective assembly positions in the puffing machine.

When turning on the motor switch 104, the motor 101 drives the pulley friction wheel 105 rotating by the main belt 110.

As pressing on the tightening relay switch 302, the push-pull electromagnet 301 will get direct current from the electrical control box 109 and produce magnetic force to push the bar of push-pull electromagnet 323 out of the push-pull electromagnet 301. Because the impact block 306 is secured on the bar of push-pull electromagnet 323 by using the position plate 305, the impact block 306 drives the rocking arm 308 to sway and makes the tightening friction wheel 322 to engage with the pulley friction wheel 105 so that the tightening friction wheel 322 starts to rotate. As the tightening friction wheel 322 and the tightening gear 320 are secured on the tightening shaft 321 and the tightening shaft 321 is freely set on the rocking arm 308, the tightening gear 320 will turn with the tightening friction wheel 322. The tightening gear 320 will successively drive the dual gear 310 and the dual gear 310 will drive the big dual gear 317. Both the dual gear 310 and the rocking arm 308 are freely set on the pin shaft for dual gear 311 and they possess the same turning axis. The pin shaft for dual gear 311 is secured on the dual gear support 312. The big dual gear 317 is freely set on the chamber sleeve 107. When the big dual gear 317 turning, it will drive the gear nut 316. Meanwhile, the inside thread of the gear nut 316 will move the driven plate 313 in by moving the drive screw 314 until the end surface of the driven plate 313 is against the surface of the chamber sleeve 107 because the drive screw 314 and driven plate 313 are secured together. As long as the driven plate 313 meets the chamber sleeve 107 together, the big dual gear 317 will be still. At the same time, the speed sensor 324 will send the electrical control box 109 a signal to turn off the tightening relay switch 302 so that there is no direct current flow into the push-pull electromagnet 301. Hereby, no electromagnetic force will apply on the bar of push-pull electromagnet 323 and the impact block 306. The rocking arm 308 will be put back to the neutral position by the pull-back spring 318 so that the tightening friction wheel 322 will not touch the pulley friction wheel 105. By far, the tightening process is accomplished.

Under this operating status, when some puffing food stuff is put into the hopper for puffing food stuff 111, the puffed food will be produced by the running puffing machine. If the user of the puffing machine wants to put second eatable stuff into the central area of the puffed food, the user can put the second eatable stuff into the hopper for second eatable stuff 401 so that second eatable stuff input assembly 4 will bring the second eatable stuff into the central area of the puffed food. As the puffed food comes out of the main structure of puffing machine 1, the electromagnetically cutting assembly 2 can be activated to cut the puffed food as the user's wishes.

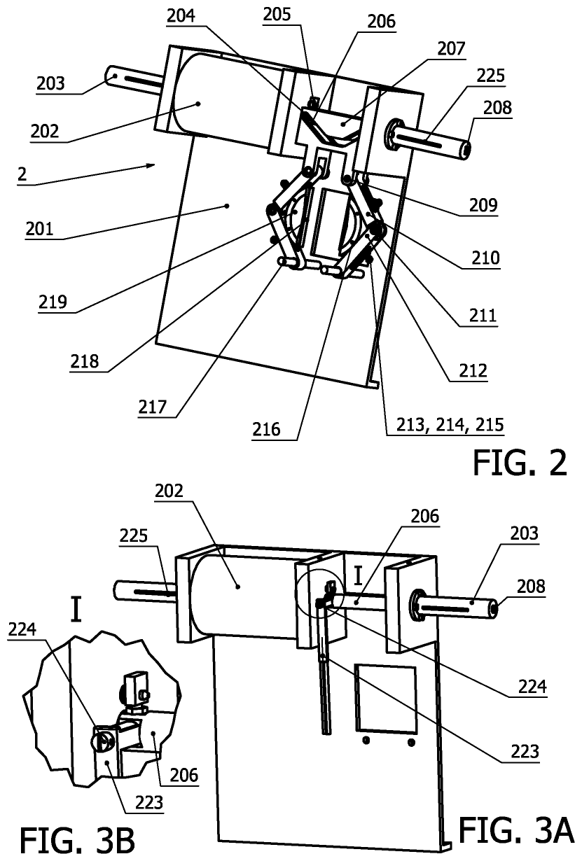

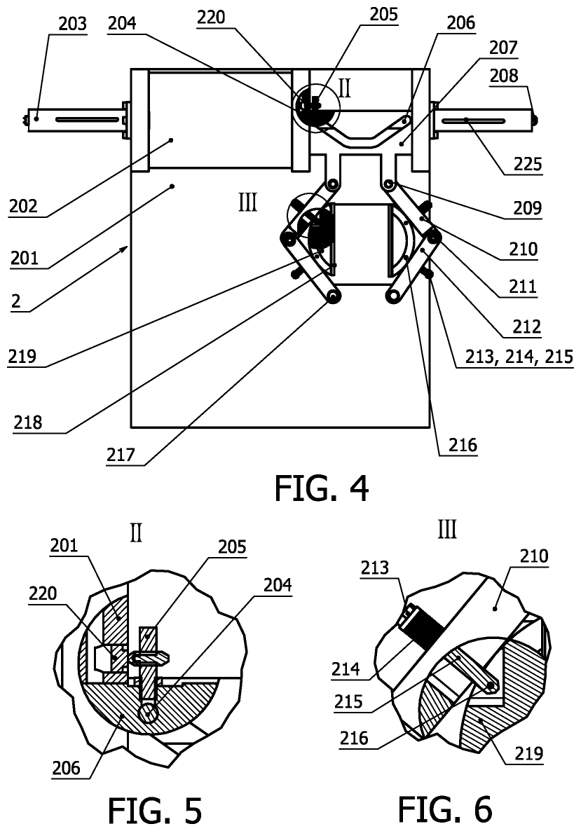

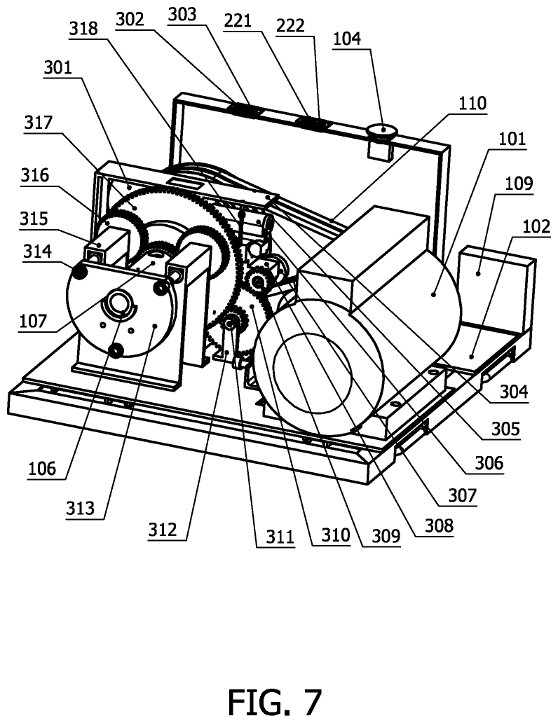

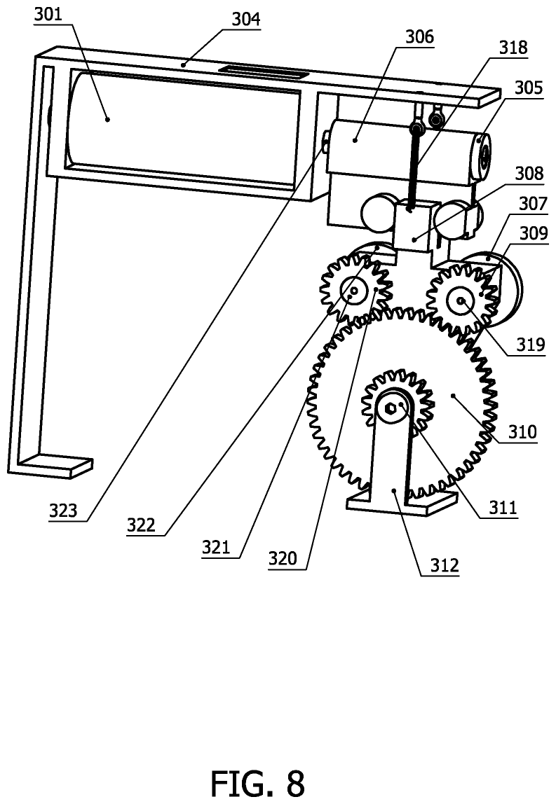

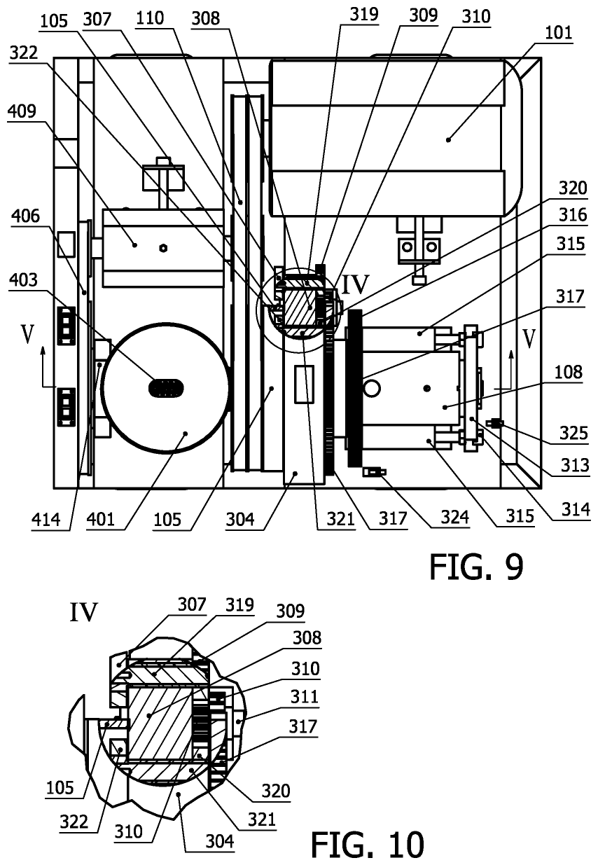

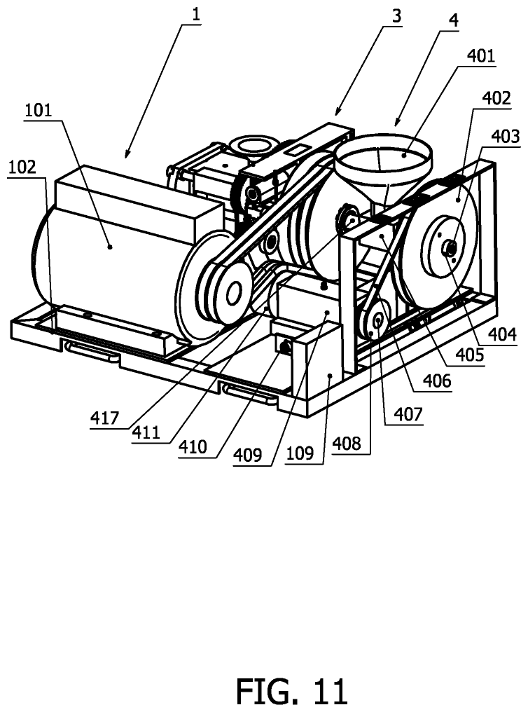

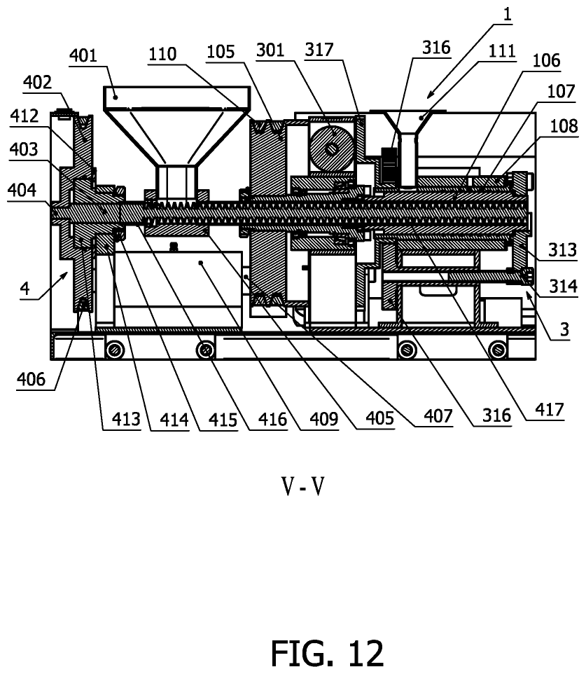

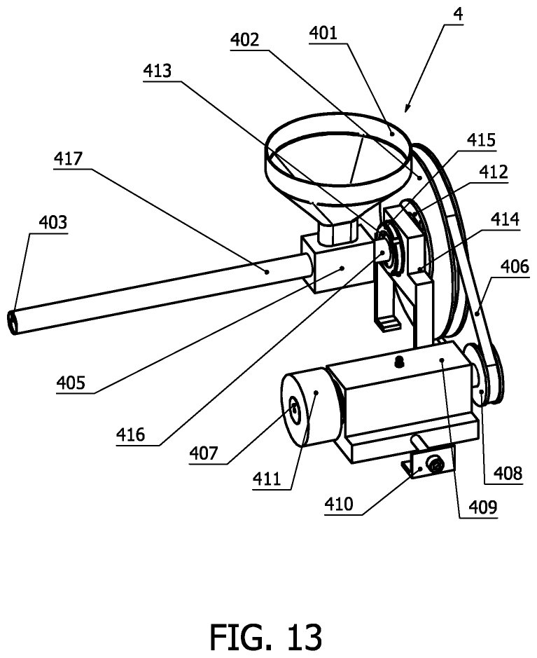

In order to cut off the puffed food, the right cut relay button 221 or the left cut relay button 222 should be pressed on so that the cut push-pull electromagnet 202 gets plus or minus direct current from the electrical control box 109. The electromagnetic force produced by the cut push-pull electromagnet 202 will make the core of push-pull electromagnet 206 quickly moving in the right or left direction. Because the V-chute shaft 204 is secured in the core of push-pull electromagnet 206, the movement of the V-chute shaft 204 causes the V-chute plate 207 rapidly to move up and down as the slope of the V-chute plate 207. As the upper arm 210 is freely set on the V-chute plate 207 by using the upper pin shaft 209; meanwhile the other end of the upper arm 210 is freely set on the lower arm 212 by using the arm pin shaft 211; and more, the other end of the lower arm 212 is freely set on the guide pin 217; the guide pin 217 is secured on the cutting assembly base 201; at the same time, the cylindrical surface of the blade seat 219 is always touched with the upper arm 210 and the lower arm 212; the blade 218 is secured on the blade seat 219; like this way, both of the blade 218 will make the parallel-type motion against the directions. When the core of push-pull electromagnet 206 brings the blades completed the cutting process and approaches the end of the movement in the right or left direction, the trigger for limit switch 205 will activate the limit switch 220 in either end. The limit switch 220 will send the electrical control box 109 a signal to stop the current supply to the cut push-pull electromagnet 202. Therefore, no electromagnetic force applies on the core of push-pull electromagnet 202. For now, the core of push-pull electromagnet 206 has just passed air opening 225 and form a scaled space with the shock absorber 203 and the check valve 208. Because of the inertia of the core of push-pull electromagnet 206, instantaneous high air pressure will be reached in the shock absorber 203. When it reaches certain value, the check valve 208 will open to leak the air pressure and to reduce the impact vibration. Because the back-position pin shaft 215 is freely set on the support pin 216, the back-position spring 214 is freely set on the back-position pin shaft 215 and is positioned by the back-position nut 213, this spring force produced by the back-position spring 214 will keep the blade 218 open if no electromagnetic force applies on the core of push-pull electromagnet 206. This type of embodiment can be seen in FIG. 2, FIG. 4, FIG. 5 and FIG. 6.

Another embodiment of cutting assembly can be seen in FIG. 3A and FIG. 3B—flying-knife type. This flying-knife type can be used when the puffed food is solid or no second eatable stuff is filled in the central area of the puffed food. This cutting assembly comprises of the cutting assembly base 201, the cut push-pull electromagnet 202, the shock absorber 203, the trigger for limit switch 205, the core of push-pull electromagnet 206, the limit switch 220, the right cut relay button 221, the left cut relay button 222, the long blade 223, the shock absorber 203, the tightening screw 224, the air opening 225, the check valve 208. When pressing on the right cut relay button 221 or left out relay button 222, the electromagnetic force will drive the core of push-pull electromagnet 206 quickly moving in the right or the left direction. Because the long blade 223 is secured on the core of push-pull electromagnet 206 by using the tightening screw 224, the long blade 223 will be driven to cut off the puffed food. Besides, the screw 224 can be extended into the horizontal slot of the cutting assembly base 201 to keep the long blade 223 in the cutting position. The process of absorbing the cutting shock is the same with the parallel-cutting type above.

When completing the puffing job, no more pulling food is fed into the puffing machine. And after the puffing food is cleaned up by running the puffing machine 1, the losing relay switch 303 can be pressed on.

When the losing relay switch 303 is pressed on, the push-pull electromagnet 301 will get anti-direct current from the electrical control box 109 and produce magnetic force to attract the bar of push-pull electromagnet 323 into the push-pull electromagnet 301. Because the impact block 306 is secured on the bar of push-pull electromagnet 323 by using the position plate 305, the impact block 306 drives the rocking arm 308 to sway and makes the losing friction wheel 307 to engage with the pulley friction wheel 105 so that the losing friction wheel 307 starts to turn. As the losing friction wheel 307 and the losing gear 309 are secured on the losing shaft 319 and the losing shaft 319 is freely set on the rocking arm 308, the losing gear 309 will turn along with the losing friction wheel 307. The losing gear 309 will successively drive the dual gear 310 and the dual gear 310 will drive the big dual gear 317. Both the dual gear 310 and rocking arm 308 are freely set on the pin shaft for dual gear 311 and they possess the same turning axis because the pin shaft for dual gear 311 is secured on the impact support 312. The big dual gear 317 is freely set on the chamber sleeve 107. When the big dual gear 317 turning, it will drive the gear nut 316 in the opposite direction. Meanwhile, the inside thread of the gear nut 316 will move the driven plate 313 out by moving the drive screw 314 until the end surface of the driven plate 313 is detected by the limit sensor 325 because the drive screw 314 and the driven plate 313 are secured together. As long as the driven plate 313 arrives the limit position set by the limit sensor 325, the limit sensor 325 will send the electrical control box 109 a signal to turn off the losing relay switch 303 so that there is no current in the push-pull electromagnet 301. Hereby, no electromagnetic force will apply on the bar of push-pull electromagnet 323 and the impact block 306. The rocking arm 308 will be put back to the neutral position by the pull-back spring 318. And the losing friction wheel 307 will not touch the pulley friction wheel 105 anymore. So far, the losing process is finished.

As for the electromagnetically tightening & losing assembly 3, at least one push-pull electromagnet 301 is applied in the electromagnetically tightening and losing assembly so that the power can be transmitted to the losing friction wheel 307 or the tightening friction wheel 322.

As for the electromagnetically tightening & losing assembly 3, the turning axis of the rocking arm 308 has the same turning axis of the dual gear 310 so that the tightening gear 320 and the losing gear 309 are always engaged with the dual gear 310.

As for the electromagnetically tightening & losing assembly 3, the transmission method between the pulley friction wheel 105 and the tightening friction wheel 322 or the losing friction wheel 307 is friction drive.

As for the electromagnetically tightening & losing assembly 3, the transmission methods between the dual gear 310 & the losing gear 309 or the tightening gear 320 and between the dual gear 310 & the big dual gear 317 and between the big dual gear 317 & the gear nut 316 are gear transmission and the transmission methods can also be replaced by friction drive or chain transmission.

As for the electromagnetically tightening & losing assembly 3, the base for push-pull electromagnet 304, the drive support 315 and the dual gear support 312 can be made one piece with the main base 102 in the main structure of puffing machine 1.

As for the electromagnetically tightening & losing assembly 3, at least one pair of the drive screw 314 and the gear nut 316 is applied in the assembly.

As for the electromagnetically tightening & losing assembly 3, at least one pull-back spring 318 are applied in the assembly.

As for the electromagnetically tightening & losing assembly 3, the big dual gear can also be freely set on other static part, such as on the sleeve support 108.

As for the electromagnetically tightening & losing assembly 3, the tightening relay switch 302 and the losing relay switch 303 can be used as the control ports of the digital control equipment, such as Arduino, Raspberry PI, PLC . . . etc.

As for the electromagnetically cutting assembly 2, at least one cut push-pull electromagnet 202 exists in the assembly.

As for the electromagnetically cutting assembly 2, at least one the blade 218 (the other side can be replaced by the cutting assembly base 201), or the long blade 223 is applied in the electromagnetically cutting assembly.

As for the electromagnetically cutting assembly 2, at least one the back-position spring 214 is applied in the electromagnetically cutting assembly so that the cutting blade(s) will be kept in the opening position when no current in the cut push-pull electromagnet 202.

As for the electromagnetically cutting assembly 2, at least one air opening 225 is applied in the shock absorber 203.

As for the electromagnetically cutting assembly 2, the movement of the V-chute plate 207 is perpendicular to the axis of the core of push-pull electromagnet 206.

As for the electromagnetically cutting assembly 2, the electromagnetically cutting assembly 2 is located in front of the driven plate 313 (the outlet of the puffed food).

As for the electromagnetically cutting assembly 2, the right cut relay button 221 or left cut relay button 222 can be used as the control ports of the digital control equipment, such as Arduino, Raspberry Pi, PLC . . . etc.

When the main belt 110 is driven by the motor 101, the position of the tensioner 411 can be changed by belt adjustment 410. The tension of belt 406 can also be adjusted by the tensioner 411, the belt adjustment 410, the base for tensioner 409 and the tensioner shaft 407. At the same time, the power is also transferred to the small pulley 408 because both the tensioner 411 and the small pulley 408 are secured on both ends of the tensioner shaft 407. The big pulley 402 is freely set on the big pulley shaft 413 and uses the big pulley plate 412 to keep the big pulley 402 running on the big pulley shaft 413. The big pulley shaft 413 is secured on the shaft base 414 by using the tightening nut 415. The long screw 403 is freely set in the big pulley shaft 413 and is also secured with the big pulley 402 by using the cotton pin 404. The connection sleeve 416 is secured on the big pulley shaft 413. The linkage 405 is secured on the connection sleeve 416. And the hopper for second eatable 401 and the long tube 417 are secured on the linkage 405.

As for the second catable stuff input assembly 4, the hopper for second eatable stuff 401 is on the top of the long screw 403 and between the big pulley 402 and the pulley friction wheel 105 in the main structure of puffing machine 1.

As for the second eatable stuff input assembly 4, the tension of the belt 406 can be changed by using the belt adjustment 410.

As for the second eatable stuff input assembly 4, the long screw 403 is inside of the long tube 417 so that the second eatable stuff can be brought to the central area of the puffed food.

As for the second eatable stuff input assembly 4, the tensioner 411 is driven by the main belt 110 of the main structure of puffing machine 1 so that the second eatable stuff input assembly 4 can obtain the drive power from it.

As for the second eatable stuff input assembly 4, the shaft base 414 and the base for tensioner 409 can be made one piece with the main base 102 in the main structure of puffing machine 1.

As for the second eatable stuff input assembly 4, the belt drive between the big pulley 402, the belt 406 and the small pulley 408 can also be replaced by gear or chain transmission.

Although the present invention has been described in considerable detail with reference to certain preferred versions thereof other versions are possible. Therefore, the spirit and scope of the appended claims should not be limited to the description of the preferred versions contained therein. Any element in a claim that does not explicitly state ‘means for’ performing a specified function, or “step for” performing a specified function, is not to be interpreted as a “means” or “step” clause as specified in 35 U.S.C. § 112, (f). In particular, the use of “step of” in the claims is not intended to invoke the provisions of 35 U.S.C. § 112, (f).

What is claimed is:

1. The electromagnetically tightening and losing assembly 3, comprising:
The main structure of puffing machine 1, the push-pull electromagnet 301, the tightening relay switch 302, the losing relay switch 303, the base for push-pull electromagnet 304, the position plate 305, the impact block 306, the losing friction wheel 307, the rocking arm 308, the losing gear 309, the dual gear 310, the pin shaft for dual gear 311, the dual gear support 312, the driven plate 313, the drive screw 314, the drive support 315, the gear nut 316, the big dual gear 317, the pull-back spring 318, the losing shaft 319, the tightening gear 320, the tightening shaft 321, the tightening friction wheel 322, the bar of push-pull electromagnet 323, the speed sensor 324, the limit switch 325.

2. The assembly according to claim 1, wherein said the push-pull electromagnet 301 is driven by the direct current.

3. The assembly according to claim 1, wherein said the transmission method between the pulley friction wheel 105 and the tightening friction wheel 322 or the losing friction wheel 307 is friction drive.

4. The assembly according to claim 1, wherein said at least one screw transmission between the drive screw 314 and the gear nut 316 is applied in the electromagnetically tightening and losing assembly 3.

5. The assembly according to claim 1, wherein said the rocking arm 308 and the dual gear 310 have the same turning axis.

6. The assembly according to claim 1, wherein said the tightening relay switch 302 and the losing relay switch 303 can also be used as the control ports of digital control equipment, such as Arduino, Raspberry Pi, PLC etc. . . .

7. The assembly according to claim 1, wherein said at least one pull-back spring 318 is applied to keep the tightening friction wheel 322 and the losing friction wheel 307 in the neutral position and no touch with the pulley friction wheel 105 when no direct current in the push-pull electromagnet 301.

8. The electromagnetically cutting assembly 2, comprising:
The main structure of puffing machine 1, the cutting assembly base 201, the cut push-pull electromagnet 202, the shock absorber 203, the V-chute shaft 204, the trigger for limit switch 205, the core of push-pull electromagnet 206, the V-chute plate 207, the check valve 208, the upper pin shaft 209, the upper arm 210, the arm pin shaft 211, the lower arm 212, the back-position nut 213, the back-position spring 214, the back-position pin shaft 215, the support pin 216, the guide pin 217, the blade 218, the blade seat 219, the limit switch 220, the right cut relay button 221, the left cut relay button 222, the air opening 225.

9. The assembly according to claim 8, wherein said at the cut push-pull electromagnet 202 is driven by the direct current.

10. The assembly according to claim 8, wherein said at least one blade 218 is applied in the electromagnetically cutting assembly 2.

11. The assembly according to claim 8, wherein said at least one the back-position spring 214 is applied in the electromagnetically cutting assembly 2.

12. The assembly according to claim 8, wherein said at least one air opening 225 in the shock absorber 203.

13. The assembly according to claim 8 wherein said the movement of the V-chute plate 207 is perpendicular to the axis of the core of push-pull electromagnet 206.

14. The assembly according to claim 8, wherein said the electromagnetically cutting assembly 2 is located in front of the driven plate 313.

15. The assembly according to claim 8, wherein said the right cut relay button 221 and the left cut relay button 222 can also be used as the control ports of digital control equipment, such as Arduino, Raspberry Pi, PLC etc.

16. The second eatable stuff input assembly 4, comprising:
The main structure of puffing machine 1, the hopper for second eatable stuff 401, the big pulley 402, the long screw 403, the cotton pin 404, the linkage 405, the belt 406, the tensioner shaft 407, the small pulley 408, the base for tensioner 409, the belt adjustment 410, the tensioner 411, the big pulley plate 412, the big pulley shaft 413, the shaft base 414, the tightening nut 415, the connection sleeve 416, the long tube 417.

17. The assembly according to claim 16, wherein said the tension of the belt 406 can be changed by using belt adjustment 410.

18. The assembly according to claim 16, wherein said the long screw 403 is inside of the long tube 417 so that the second eatable stuff can be brought to the central area of the puffed food.

19. The assembly according to claim 16, wherein said the tensioner 411 is driven by the main belt 110 of the main structure of puffing machine 1.

20. The assembly according to claim 16, wherein said the hopper for second eatable stuff 401 is located between the big pulley 402 and the pulley friction wheel 105 in the main structure of puffing machine 1.
